(19) United States
(12) Patent Application Publication
(10) Pub. No.: US 2008/0211677 A1
(43) Pub. Date: Sep. 4, 2008

(54) Child safety alarm

(76) Inventor: Jules R. Shecter, Boca Raton, FL (US)

Correspondence Address: ROBERT M. DOWNEY, P.A., 6751 N. FEDERAL HWY., SUITE 300, BOCA RATON, FL, 33487, US

(21) Appl. No.: 12/079,515

(22) Filed: Mar. 27, 2008

Related U.S. Application Data
(63) Continuation of application No. 11/437,927, filed on May 19, 2006.
(60) Provisional application No. 60/683,209, filed on May 20, 2005.

(51) Int. Cl. G08B 23/00

(52) U.S. Cl. 340/573.1

(57) ABSTRACT

A child safety alarm device has a main housing that protectively contains electronics, a battery power source, a digital display clock and an audible alarm. When activated, the alarm generates a loud audible signal that preferably includes a repeating voice message combined with an intermittent shrill noise in the audible range of between 80 to 100 decibels. A flexible band, constructed of materials that resist cutting, extends from the main housing and wraps around a child's wrist or ankle. The audible alarm signal is activated by depressing a panic button on the main housing, concealed below a protective cover, or, alternatively, with the use of a wireless remote control device carried by a parent or guardian. Deactivation of the continuous audible alarm signal requires entry of a predetermined code using entry buttons on the device housing.

This non-provisional patent application is a continuation patent application of co-pending non-provisional patent application Ser. No. 11/437,927 filed on May 19, 2006 which is based on provisional patent application No. 60/683,209 filed on May 20, 2005.

### BACKGROUND OF THE INVENTION

1. Field of the Invention

The present invention is directed to a personal safety alarm and, more particularly, to a child safety alarm that releasably locks on the wrist or ankle, and which is adapted to emit an audible alarm signal that may include a voice message and/or a shrill noise, and wherein the audible alarm signal is activated by depressing a panic button on either the alarm device or a wireless remote control and, further, wherein deactivation of the alarm device requires entry of a predetermined code using entry buttons on the device.

2. Discussion of the Related Art

According to data from the National Crime Information Center, approximately 2,000 children under 18 years of age are reported missing each day. The United States Department of Justice reports that each year there is a total of over 450,000 attempted child abductions, 4,000 of which are successfully committed by strangers. Most abductions occur close to home and more than half of child abduction/murders are committed by strangers. Child victims are typically from middle class families living in a functional family environment. It is well know that the best chances of survival occur within the first few minutes of an attempted abduction. Once a child is in the captivity of the abductor, chances of survival dramatically decrease. If the child is not located by searching authorities within the first few hours of abduction, the odds of recovering the child alive are extremely low.

The number of child abductions and kidnappings in the United States and most other countries is of serious concern. While the implementation of security measures, such as the AMBER ALERT, have been helpful to both curtail the number abductions and increase the successful recovery rate, these measures are only instituted after the abduction occurs. The best way to stop child abductions and kidnappings is to prevent them from occurring in the first place. One of the most effective means to stop a child abductor is to sound a very loud audible alarm when the potential abductor first approaches and attempts to take the child. This has the effect of causing the potential abductor to panic and flee the scene. However, if the abductor is able to deactivate the alarm or quickly separate the child from the alarm, such a measure may not be entirely effective.

Accordingly, there remains a need for a child safety alarm which is adapted to be locked to the child's body, preferably about the wrist or ankle, and which is adapted to emit a loud audible alarm signal to deter a potential abductor and save the child from abduction. Moreover, there is a need for a child safety alarm device that releasably locks to the child's wrist or ankle, and which includes a concealed panic button that can be quickly accessed by a child to activate the loud audible alarm signal in the event of an attempted abduction, and wherein the alarm signal continues to sound until deactivated by entry of a predetermined code using entry buttons on the device.

### SUMMARY OF THE INVENTION

The present invention is directed to a child safety alarm structured to be removably locked to a child's body, preferably around the wrist or ankle. The device includes a main housing that protectively contains electronics including circuitry with a programmable memory and a controller. The housing also contains a battery power source and an audible alarm. When activated, the alarm generates a loud audible signal that preferably includes a repeating voice message followed by a shrill noise in the audible range of between 80 to 100 decibels. A flexible band, constructed of materials that resist cutting, has strap members that extend from the main housing and wrap around the wrist or ankle to secure the safety alarm device to the child. An electronic locking mechanism, powered by the battery source, locks the straps closed, to prevent unauthorized removal of the device from the child. In a preferred embodiment, the safety alarm device is provided in the form of a wristwatch and includes a programmable, digital clock with display on the main housing. The audible alarm signal is activated by depressing a panic button on the main housing, concealed below a protective cover, or, alternatively, with the use of a wireless remote control device carried by a parent or guardian. Release of the locked securing straps and deactivation of the otherwise continuous audible alarm signal requires entry of a predetermined code using entry buttons on the device housing.

### OBJECTS AND ADVANTAGES OF THE INVENTION

With the foregoing in mind, it is a primary object of the present invention to provide a child safety alarm device that removably locks to a child's wrist or ankle and which is provided with a concealed panic button that can be quickly accessed by a child to activate a loud audible alarm signal in the event of an attempted abduction.

It is a further object of the present invention to provide a child safety alarm device that releasably locks to a child's wrist or ankle and which requires entry of a predetermined code to release the device from attachment to the child's wrist or ankle.

It is still a further object of the present invention to provide a child safety alarm device that releasably locks to a child's wrist or ankle and which is constructed of materials that resist cutting and unauthorized removal of the device from the child's wrist or ankle.

It is still a further object of the present invention to provide a child safety alarm device that includes a concealed panic button which can be quickly accessed by a child to activate a loud audible alarm signal which continues to sound until deactivated by entry of a predetermined code using entry buttons on the device.

It is still an object of the present invention to provide a child safety alarm device that produces a loud audible alarm signal in the range of between 80-100 decibels.

It is still a further object of the present invention to provide a child safety alarm device as set forth above, and wherein the loud audible alarm signal includes one or more voice messages.

It is yet a further object of the present invention to provide a child safety alarm device as set forth above, and wherein the loud audible alarm signal includes one or more voice messages that continuously repeat until the alarm is deactivated by entry of a predetermined code using entry buttons on the device.

It is still a further object of the present invention to provide a child safety alarm device, wherein the loud audible alarm signal includes one or more voice messages which sound continuously and repeat alone or in combination with a loud shrill noise.

It is yet a further object of the present invention to provide a child safety alarm device that allows for selective activation of two or more alarm signals which emit a loud audible voice message, including a first voice message that says “Help, Call Police” and a second voice message that says “Help, I Am Lost.”

It is still a further object of the present invention to provide a child safety alarm device that includes a wireless remote control for activating the audible alarm signal on the alarm device attached to the child.

It is still a further object of the present invention to provide a child safety alarm device, wherein the wireless remote control is adapted to selectively activate any one of several voice messages emitted from the alarm device worn on the child including “Help, Call Police” or “Help, I Am Lost” as well as a loud shrill alarm noise.

It is still a further object of the present invention to provide a child safety alarm device, as set forth above, that further includes an independent control device which is adapted for connection to the alarm device for supplying temporary power and entry of the predetermined alarm code in order to unlock and remove the child alarm device from the child in the event of loss of sufficient energy from a battery power source within the alarm device.

These and other objects and advantages of the present invention are more readily apparent with reference to the following detailed description and accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a top side perspective view showing the child safety alarm device in the form of a wristwatch in accordance with a preferred and practical embodiment thereof;

FIG. 2 is an isolated perspective cut-away view of a locking clasp on the wristband of the child safety alarm device of FIG. 1 for releasably locking the wristband in a closed, locked position to secure the device on a child's wrist and to prevent unauthorized removal therefrom;

FIG. 3 is a top plan view of the child safety alarm device of FIG. 1;

FIG. 4 is a perspective view showing the child safety alarm device of FIG. 1 with a protective dome cover hinged open to reveal a panic button which, when depressed, activates a loud audible alarm signal continuously emitted from the device;

FIG. 5 is side perspective view showing a remote control device for use in conjunction with the child safety alarm device of FIGS. 1-4 in order to selectively activate any one of a number of alarm signals emitted from the child safety alarm device at a location remote from the alarm device;

FIG. 6 is a side elevational view of the remote control device of FIG. 5 illustrating opening of a protective cover to reveal one or more actuation control buttons used for remotely activating the audible alarm signal on the child safety alarm device;

FIG. 7 is a schematic diagram of the electronic components of the child safety alarm device;

FIG. 8 is a schematic diagram of the remote control device; and

FIG. 9 is a perspective view showing a battery recharger plugged into the child safety alarm device.

Like reference numerals refer to like parts throughout the several views of the drawings.

### DETAILED DESCRIPTION OF THE PREFERRED EMBODIMENT

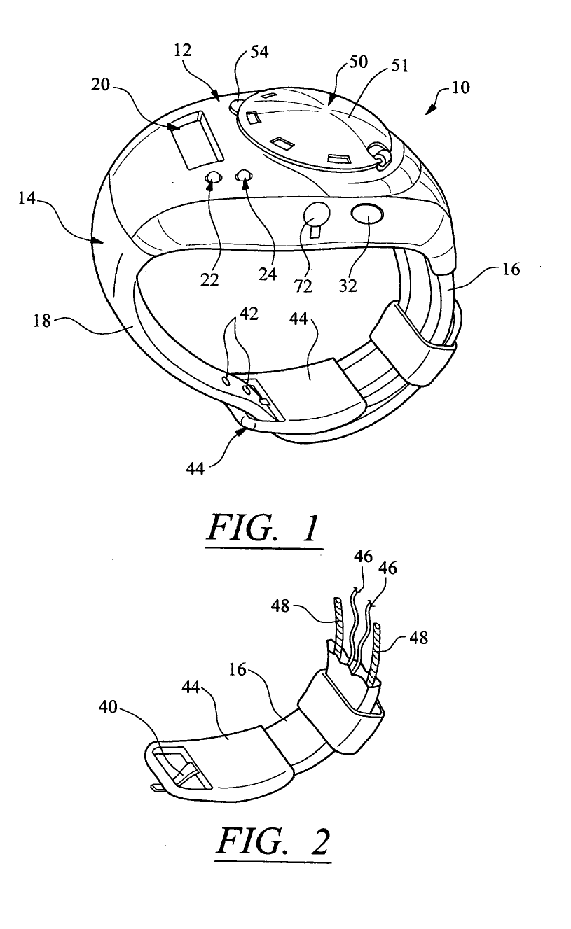

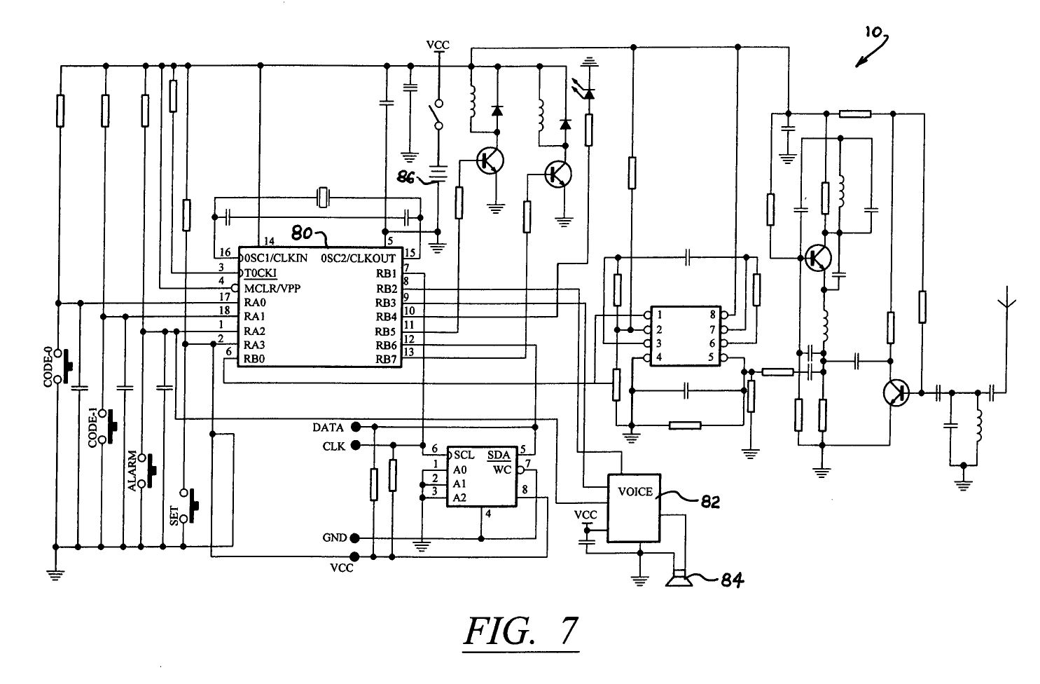

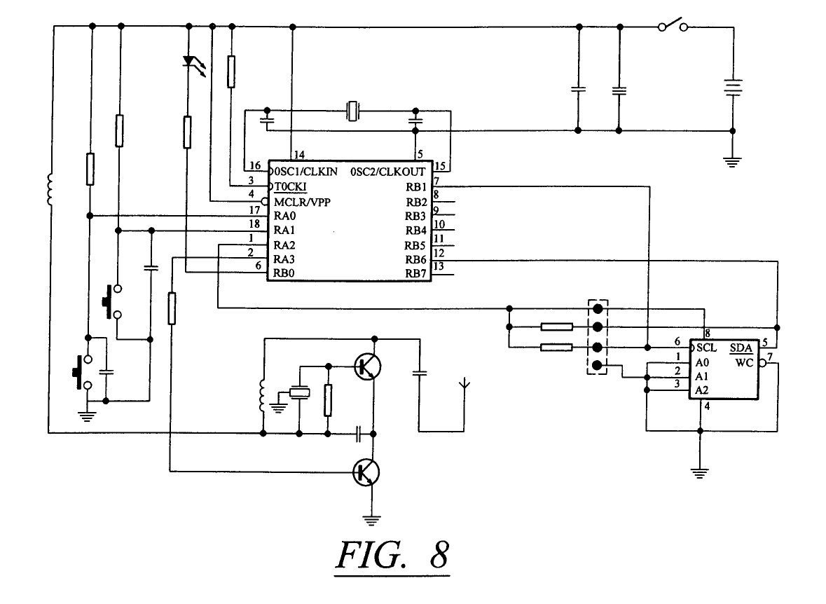

Referring to the several views of the drawings, and initially FIGS. 1-4, the child safety alarm device is shown and is generally indicated as 10. The alarm device 10 includes a main housing 12 that protectively contains the electronic components depicted in the schematic diagram in FIG. 7. The electronic components include circuitry with a programmable memory and a controller. The electronic components also include a sound generating device, including a speaker capable of audibly transmitting sounds at levels of 80 to 100 decibels or higher. Sound patterns for transmission by the sound generating device are stored as data on the programmable memory. The generated and transmitted sound patterns provide an audible alarm signal. A rechargeable battery is also contained within the housing for supplying electric power to the various components. The controller receives entry commands and controls operation of the other components.

A flexible band 14 includes strap members 16, 18 that extend from the housing. The strap members 16, 18 are specifically adapted to wrap around a child's wrist or ankle to releasably lock the device 10 on the child. In a preferred embodiment, as shown in FIGS. 1-4, the child safety alarm device 10 is provided in the form of a wristwatch, wherein the strap members 16, 18 are sized, structured and configured as a wristband 14 to adjustably fasten and releasably lock about a child's wrist so that the wristband is snug, not too tight, and yet securely fastened to the wrist so that the wristband 14 and housing 12 cannot be slipped over the hand and removed from the child.

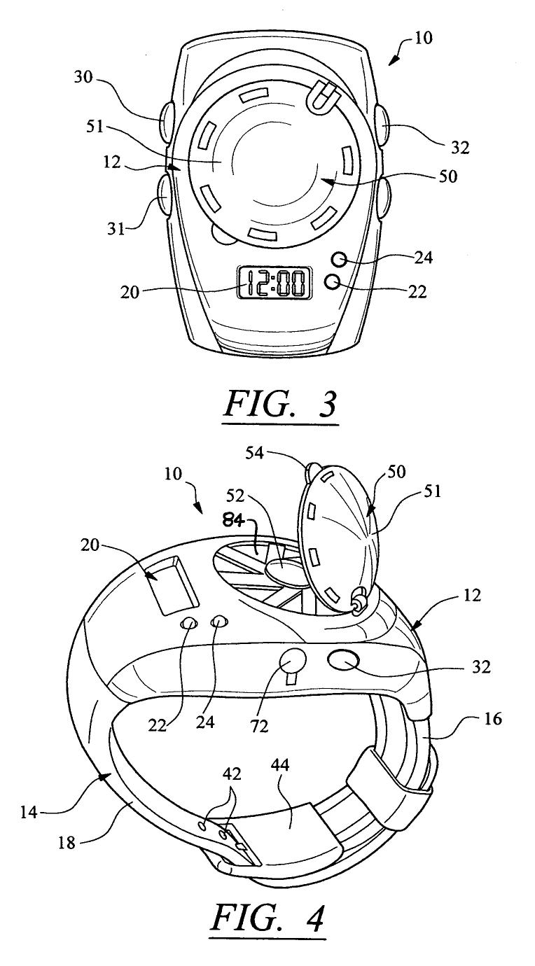

The preferred embodiment of the child safety alarm device 10 is provided in the form of a wristwatch. As seen in FIGS. 1 and 3, a digital clock display 20 is provided on the main housing 12. Programmable functions such as time of day, (hours, minutes, seconds) and date (day, month and year) are provided in the electronic circuitry which is presented in schematic form in FIG. 7. These clock functions are displayed on the digital display 20. The various functions of the digital clock are controlled using buttons on the main housing 12, including a mode selection button 22 for selecting the particular function, and a select button 24 for changing displayed information such as the time and date.

The device 10 is further provided with alarm code programming and control buttons, 30, 31 and 32 on the main housing 12. The alarm control buttons 30, 31 and 32 are preferably of different colors, (e.g., blue, white and red) and are used to control various functions of the audible alarm, including programmed entry of one or more personal codes for deactivating the alarm. In particular, depressing both alarm buttons 30, 32 simultaneously, serves to self-test the alarm device. More particularly, depressing both buttons simultaneously activates the alarm device causing the loud audible alarm signal to sound continuously for a predetermined test period (e.g., 15 seconds). After the test period expires, the alarm device is deactivated and the audible alarm signal ceases. The alarm controls 30, 32 are also used to set and subsequently enter a predetermined alarm code used for deactivating the audible alarm to thereby shut off the audible alarm signal, as described more fully hereinafter. Other features of the alarm device are controlled using the push buttons, 30, 31 and 32. Information such as the entered code are displayed on the display 20.

In one embodiment of the invention, the wristband 14, comprising strap members 16, 18, is designed to releasably lock to the child's wrist. In this instance, a preferred lock feature in the wristband is electronically controlled by the circuitry contained in the main housing 12. In the unlocked state, a locking finger 40 is able hinge back and forth to facilitate manipulation in and out of adjustment holes 42 provided at spaced intervals along the opposing strap 18. As seen in FIG. 2, the locking finger 40 is provided on the locking clasp 44 secured to the end of strap 14. An electronic locking device is contained within the clasp 44 and controls movement of the finger 40. The locking mechanism within the clasp 44 is wired to the circuitry in the housing 12 via conductors 46 which extend through the interior of the strap band 14. When in the locked mode, using the push button controls on the housing 12, the locking finger 40 is fixed in rigid position preventing removal from a selected aperture 42 on the opposing strap 18, and thereby maintaining the strap 18 secured through the locking clasp 44 and locked to opposing strap 16. Entry of predetermined release code, using the control buttons 30, 31 and 32 on the main housing 12, serves to actuate the electronic locking mechanism within the clasp 44 to release the finger 40 from fixed position, thereby allowing the finger 40 to hinge or pivot so that the strap 18 can be removed from the clasp 44, thereby enabling removal of the device 10 from the child's wrist. Both straps 16 and 18 are provided with one or more internal steel cables 48 that resist cutting by a knife, shears or other appliance. The internal steel cables 48, within the strap members 16 and 18, prevent the unauthorized removal of the device 10 when locked to the child's wrist. Other preferred embodiments provide a plastic or other heavy duty, durable material wristband with a pivoting finger on one strap and an arrangement of holes on the opposite strap for adjustable sizing, and wherein the distal end of the pivoting finger includes an enlarged bulb that is sized to pass through the holes on the opposite strap.

A dome shaped cover 50 on the top of the housing 12 conceals a panic button 52. The panic button 52 is depressed or otherwise operated to activate the audible alarm device that produces the loud audible signal. The dome shaped cover 50 has a top exterior side 51 which is shaped and configured to generally conform with the overall exterior configuration of the housing 12 so that when the dome cover 50 is closed, as seen in FIGS. 1 and 3, the cover 50 is generally flush with the surrounding exterior surface of the housing 12. The protective cover 50 is normally secured closed to conceal the panic button 52 so that the panic button 52 is not accidentally depressed. In the event of an attempted abduction, or other emergency situation, the child wearing the device 10 opens the protective cover 50 to reveal the panic button 52. The child can then depress or otherwise operate the panic button 52 to actuate sounding of the audible alarm signal. The access door hinges open by either lifting on tab 54 or by depressing the dome shaped cover 50 downwardly to release a push-push spring switch that releases the cover 50 and allows the cover to hinge open. In a preferred embodiment, the alarm signal is broadcast from powerful high decibel speakers. In one embodiment, the audible alarm signal is in the range of between 80 to 100 decibels. The alarm signal may include any one or more voice messages alone or in combination with a loud shrill alarm. In a preferred embodiment, the panic alarm, activated by depressing the panic switch 52, emits an alarm signal with a verbal command “Help, Call Police” which is continuously repeated with an intermittent shrill alarm noise between the voice message. A second alarm voice signal provides the verbal command “Help, I Am Lost” which is continuously repeated alone or in combination with a loud shrill noise. Regardless of the particular voice command message or other audible alarm signal, it is important to note that the signal is continuous until deactivated by entry of a predetermined alarm deactivation code using the push buttons 30, 31 and 32 on the device 10. Until deactivated, using the push button controls to enter the secret code, the audible alarm will continue to sound, with the repeating verbal command, until the battery power source is exhausted. In a preferred embodiment, the device is powered by a 10,000 hour internal battery. It is further noted that the alarm device 10 is water resistant and highly durable to resist attempted destruction.

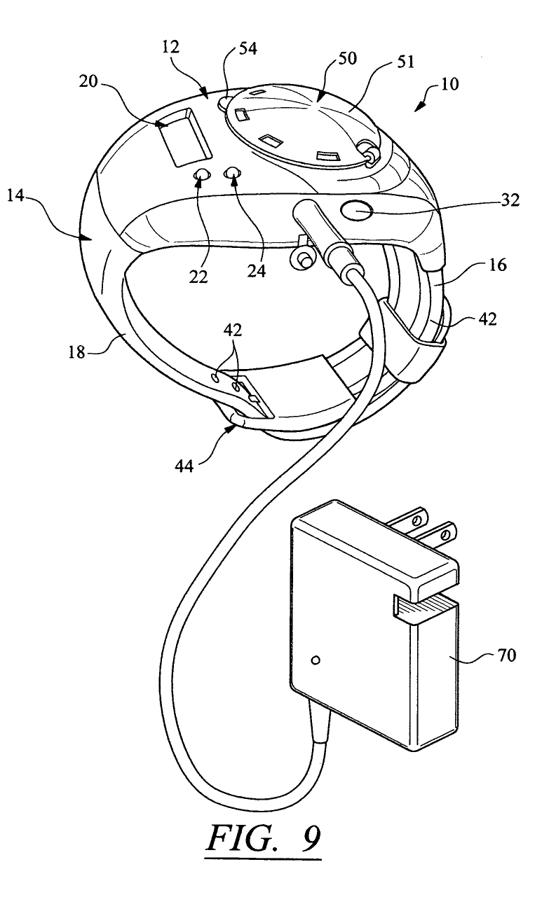

In the event the battery power becomes low or is exhausted, and the device 10 remains locked to the child's wrist, an external control device is provided which plugs into the control circuitry of the device 10 to provide a means for entering the code along with sufficient auxiliary battery power to perform release of the lock mechanism within the clasp 44 and release of the finger 40 from locked position, thereby allowing the straps 14, 16 to be separated and removed from the child's wrist. Alternatively, a battery recharger 70 (see FIG. 9) can be plugged into recharger port 72 on the side of the housing 12. The battery recharger 70 then plugs into a standard 110 volt (or equivalent) power supply outlet to energize the circuitry and allow release of the finger 40 so that the device can be removed from the child's wrist or ankle. Leaving the battery recharger 70 plugged in will allow the internal batteries to recharge.

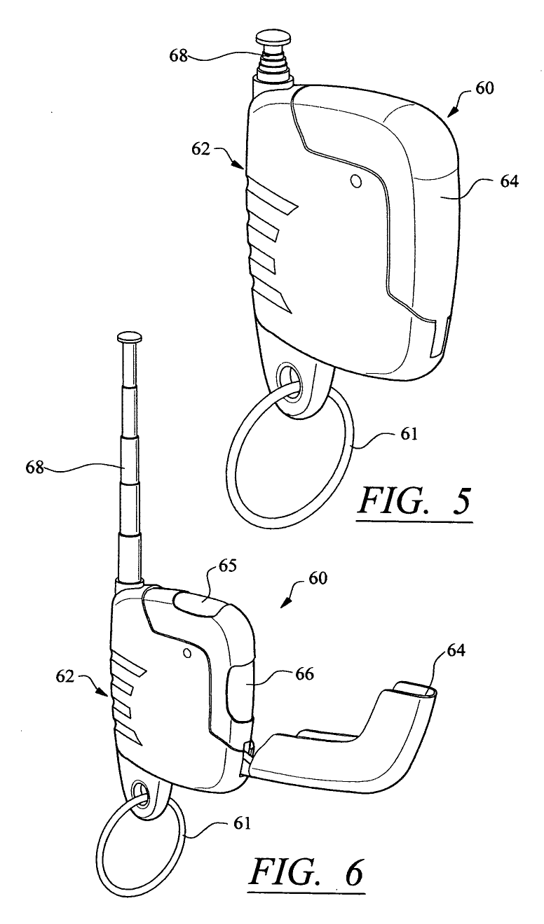

FIGS. 5 and 6 illustrate a remote control device 60 which is intended to be carried by a parent or guardian of the child wearing the alarm device 10. The remote control device 60 may be carried on a keychain ring 61 and includes a housing 62 and a hinged cover 64 which opens (see FIG. 6) to reveal one or more control buttons for remotely activating the alarm device 10 worn on a child's wrist. Specifically, the remote control device 60 may be provided with a panic button 65 to activate emission of the alarm signal from the child safety alarm device 10 worn on a child's wrist. The alarm signal may include the repeating verbal command “Help, Call Police” or other loud audible alarm signal. A second control button 66 is provided for activating the verbal command “Help, I Am Lost” which is emitted from the child safety alarm device 10 worn on a child's wrist. This remote activation is particularly useful in the event the child becomes separated from the parent in a public location, such as in a shopping mall or amusement park. The remote control device 60 uses a wireless signal that is transmitted by a signal transmitter in the remote control 60. The transmitted signal is received by a receiver carried within the circuitry of the child safety alarm device 10. An extendable antenna 68 on the remote control 60 enhances the transmission range of the signal. In a preferred embodiment, the transmitter and receiver have a range of up to at least 250 feet, thereby allowing the parent or guardian to actuate the alarm device worn of the child's wrist from a remote location of at least 250 feet away in the event the parent becomes separated from the child. It should be noted that the range between the transmitter and receiver may be significantly greater than 250 feet and a longer range transmitter and receiver activation system is contemplated within the spirit and scope of the invention.

Although the present invention has been shown and described in accordance with a preferred and practical embodiment thereof, it is recognized that departures from the instant disclosure are fully contemplated within the spirit and scope of the present invention.

What is claimed is:

1. A child safety device comprising:
a main housing having a top side, a bottom side and opposite ends;
a plurality of components contained within said housing and including electronic circuitry, an audible sound producing device, and an electric power storage source for energizing said electronic circuitry and said audible sound producing device;
said electronic circuitry including a running clock for keeping time and date, and a programmable memory for storing data including time and date, at least one user code and at least one audible sound signal, and said electronic circuitry further including a controller;
at least one control button on said main housing for entering programmable data on said memory and control commands for delivery to said controller;
at least one alarm control on said main housing for triggering actuation of said audible sound producing device to audibly transmit said at least one audible sound signal;
a digital display on said main housing for displaying the time and date;
a band extending from said main housing for securing the device to a user; and
said controller being responsive to entry of said stored user code, using said at least one control button, to deactivate said audible sound producing device, thereby turning off said audible sound signal.

2. The child safety device as recited in claim 1 wherein said at least one audible sound signal includes a word.

3. The child safety device as recited in claim 1 wherein said at least one audible sound signal includes an arrangement of words that are repeated.

4. The child safety device as recited in claim 3 wherein said arrangement of words is HELP, CALL THE POLICE.

5. The child safety device as recited in claim 3 wherein said arrangement of words is HELP, I AM LOST.

6. A child safety device comprising:
a main housing having a top side, a bottom side and opposite ends;
a plurality of components contained within said housing and including electronic circuitry, an audible sound producing device, and an electric power storage source for energizing said electronic circuitry and said audible sound producing device;
said electronic circuitry including a running clock for keeping time and date, and a programmable memory for storing data including time and date, at least one user code and at least one audible sound signal, and said electronic circuitry further including a controller;
at least one control button on said main housing for entering programmable data on said memory and control commands for delivery to said controller;
at least one alarm control on said main housing for triggering actuation of said audible sound producing device to audibly transmit said at least one audible sound signal;
a digital display on said main housing for displaying the time and date;
a moveable cover on said main housing operable between a closed position to protectively cover and conceal said at least one alarm control, and an open position to reveal said at least one alarm control and enable operation of said at least one alarm control for triggering actuation of said audible sound producing device;
a band extending from said main housing for securing the device to a user; and
said controller being responsive to entry of said stored user code, using said at least one control button, to deactivate said audible sound producing device, thereby turning off said audible sound signal.

7. The child safety device as recited in claim 6 wherein said at least one audible sound signal includes a word.

8. The child safety device as recited in claim 6 wherein said at least one audible sound signal includes an arrangement of words that are repeated.

9. The child safety device as recited in claim 8 wherein said arrangement of words is HELP, CALL THE POLICE.

10. The child safety device as recited in claim 8 wherein said arrangement of words is HELP, I AM LOST.

11. A child safety device comprising:
a main housing having a top side, a bottom side and opposite ends;
a plurality of components contained within said housing and including electronic circuitry, an audible sound producing device, and an electric power storage source for energizing said electronic circuitry and said audible sound producing device;
said electronic circuitry including a running clock for keeping time and date, and a programmable memory for storing data including time and date, at least one user code and at least one audible sound signal, and said electronic circuitry further including a controller;
at least one control button on said main housing for entering programmable data on said memory and control commands for delivery to said controller;
at least one alarm control on said main housing for triggering actuation of said audible sound producing device to audibly transmit said at least one audible sound signal;
a digital display on said main housing for displaying the time and date;
a moveable cover on said main housing operable between a closed position to protectively cover and conceal said at least one alarm control, and an open position to reveal said at least one alarm control and enable operation of said at least one alarm control for triggering actuation of said audible sound producing device;
a remote alarm control unit including at least one alarm control button, and said at least one alarm control button being operable to transmit a wireless signal to said controller in said main housing for triggering actuation of said audible sound producing device to audibly transmit said at least one audible sound signal;
a band extending from said main housing for securing the device to a user; and
said controller being responsive to entry of said stored user code, using said at least one control button, to deactivate said audible sound producing device, thereby turning off said audible sound signal.

12. The child safety device as recited in claim 11 wherein said at least one audible sound signal includes a word.

13. The child safety device as recited in claim 11 wherein said at least one audible sound signal includes an arrangement of words that are repeated.

14. The child safety device as recited in claim 13 wherein said arrangement of words is HELP, CALL THE POLICE.

15. The child safety device as recited in claim 13 wherein said arrangement of words is HELP, I AM LOST.
